(19) United States
(12) Patent Application Publication
(10) Pub. No.: US 2009/0019291 A1
(43) Pub. Date: Jan. 15, 2009

(54) BACKUP AND RESTORATION OF DRM SECURITY DATA

(75) Inventor: Bruce Murray, Eastleigh (GB)

Correspondence Address: NXP, B.V.;NXP INTELLECTUAL PROPERTY DEPARTMENT, M/S41-SJ, 1109 MCKAY DRIVE, SAN JOSE, CA, 95131, US

(73) Assignee: KONINKLIJKE PHILIPS ELECTRONIC, N.V., EINDHOVEN (NL)

(21) Appl. No.: 10/597,083

(22) PCT Filed: Jan. 11, 2005
(86) PCT No.: PCT/IB2005/050125

§ 371 Date: Jul. 11, 2006

(30) Foreign Application Priority Data
Jan. 13, 2004 (GB) 0400663.1

(51) Int. Cl. G06F 12/14; H04L 9/14; G06F 12/16

(52) U.S. Cl. 713/193; 380/277; 711/162; 711/E12.092; 711/E12.001

(57) ABSTRACT

The present invention provides for a method of security data restoration for a user device for back-up purposes in which the said security data can be restored through the interaction of a first and at least a second portion of data, including the steps of storing the first portion of data on a storage medium remote from the device, writing the at least second portion of data to wireless storage means, and, when restoration is required, communicating the at least second portion of data from the wireless storage means to the said storage medium so as to allow for the interaction of the first and the at least second portion of data.

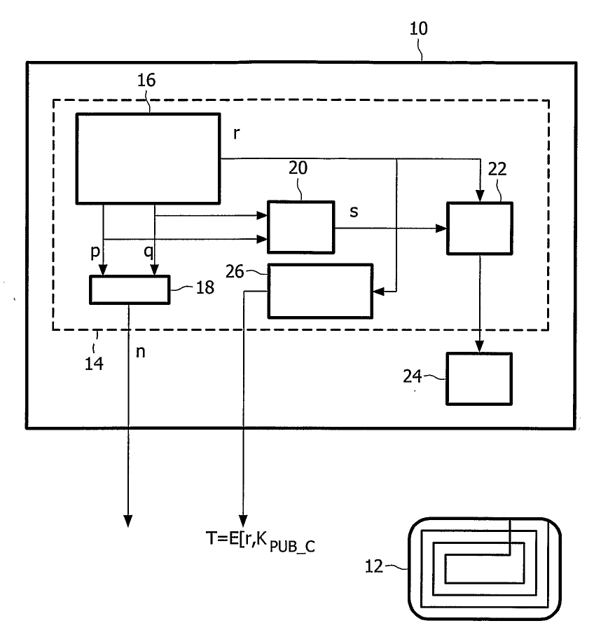

The present invention relates to a secure data handling system and related method and apparatus which allows for the recreation of security data to allow for the backing-up there of.

Digital data is becoming ever more widely employed as a format for the storage, transmission and recreation of a wide variety of media including audio, video and all forms of electronic data. In some circumstances, for example when handling digital data representing media of high value, or comprising features the access to which should be limited to predetermined parties, it is common to add a security layer to the handling of the data so as to prevent access to the data by unauthorised parties which can assist in preventing unauthorised coping etc.

Such Digital Rights Management (DRM) systems can be provided for devices arranged for handling digital data and more increasingly, to small mobile devices such as Personal Digital Assistants (PDAs) and mobile radio communication devices such as cellular phones.

A common means of achieving the required level of security is through the employment of encryption technology and in particular cryptographic keys.

With such known systems, two forms of keys are generally produced, a public key and a private key and the systems are arranged such that the public key can be known by any party. However, the private key, while available for use only by an authorised party receiving the data, generally remains inaccessible and undisclosed.

The present invention can be incorporated within any secret-sharing scheme, such as for example that employing cryptographic keys and in an advantageously simple fashion so as to allow for the ready back-up of the cryptographic key information in a simple and relatively cost-effective manner and without prejudicing the security offered by the system.

As noted above, cryptographic keys are commonly used to allow for the secure storing of digital contents such as audio, video, electronic books etc., which are commonly purchased by a user from an on-line content sales facility.

To allow for the adequately controlled purchase of the content by the user, the content is generally stored in an encrypted form on an appropriate storage medium of the user, and so as to prevent such stored objects being useful if copied to a third party.

In accordance with the overall content security arrangement, some key information will be stored, in a buried fashion, within a domain of the user's device which is itself inaccessible to the user and which serves to prevent that user from attempting to decrypt the content otherwise than for authorised use.

Such buried key information can also only be accessed dynamically when the content is decrypted at the time of legitimate use.

In view of the high value of such digital data content, the user may well have invested considerable financial outlay in obtaining such content and the value of this content is dependent upon the user's ability to access, and use the content as and when required. In turn, the value is dependent upon the continued availability of the buried key information.

If the device containing the buried keys—for example, a smartcard—or a secured storage area within any semiconductor conducted device, suffers a failure which renders the buried key information inaccessible, then the user has lost the ability to decrypt, and therefore use, the content in respect of which he has already invested potentially high financial outlay.

Back-up systems are known which serve to allow for the recovery of the cryptographic key information should the user for some reason lose the ability to access the required key information.

Such back-up systems generally use known secret-sharing techniques, which in turn generally require the use of a trusted third party to store one portion of the security data, which will only be useful in recreating the cryptographic key information, upon receiving a second portion of security data which is held by the authorised user.

When implementing current secret-sharing schemes on, for example, a consumer electronics device, product designers face problems in relation to the recording of the user's share of the security data. Typically, the user's share of this security information comprises a large number or a long bit string, and which needs to be recorded accurately by the user for future key-restoration purposes. Furthermore, this large number or bit string should not be stored within the product itself, to avoid the possibility that failure of the product might then also obliterate the user's share of that security data.

Known arrangements provide for the presentation of the user's share of the security information on a display device and which arrangements then instruct the user to record the information manually, for example, on a separate reading such as paper. However, as noted above, the user's share can typically comprise a large number or bit string which can be of the extent of several hundred bits of information and so such an approach is found to be tedious by the user and of course is error-prone.

Alternative schemes allow for the user's share of the security data to be stored in a removable part of the device, for example a non-volatile storage element. However, restrictions arise insofar as if such a detachable element forms a functional part of the product itself, it is likely to suffer the same failure as could be suffered by the product.

According to a first aspect of the present invention there is provided a method of security data restoration for a user device for back-up purposes in which the said security data can be restored through the interaction of a first and at least a second portion of data, including the steps of storing the first portion of data on a storage medium remote from the device, writing the at least second portion of data to wireless storage means, and, when restoration is required, communicating the at least second portion of data from the wireless storage means to the said storage medium so as to allow for the interaction of the first and the at least second portion of data.

Advantageously, the use of a wireless storage means allows for a secure, reliable and low-cost solution to the secret sharing problem encountered in the prior-art and comprises one which requires little, or no, user intervention.

The reliability of the method is also not prejudiced by any device failures that might be experienced.

Preferably the security device comprises encryption data and, in particular, can comprise cryptographic key data such as data relating to the private key of a RSA public/private keypair.

The invention can be incorporated for use within a mobile device such as a mobile radio communications device and the wireless storage device advantageously comprises a near field communications device.

According to another aspect of the present invention there is provided a security data restoration system for a user device for backup purposes in which the said security data can be restored through the interaction of a first portion and at least a second portion of data, the system comprising a storage medium arranged for storing the first portion of data remote from the device, wireless storage means arranged for receiving the at least second portion of data and the system being arranged such that, when restoration is required, the at least second portion of data within the wireless storage means can be communicated to the said storage medium so as to allow for the interaction of the first and the at least second portion of data.

The system can advantageously be arranged to operate in accordance with the method steps noted above.

According to a further aspect of the present invention there is provided a method of backing-up security data of a user device and comprising the step of writing a first portion of security data to writable wireless storage means for subsequent retrieval and use in a backup procedure.

In accordance with yet another aspect of the present invention there is provided a back up device for the storage of security data derived from a user device and for subsequent use in recreating security data within the device, and comprising a wireless writable storage device.

The prevent invention seeks to provide for a security data system and related method and apparatus having advantages over known such systems, methods and apparatus.

As will be appreciated, the present invention advantageously provides for the use of a writable storage device employing near-field communications technology for the back up of security-critical data such as cryptographic key data. Secret sharing techniques are employed to ensure that the keys can only be restored by collaboration between the original holder of the lost key and a trusted third party authority. The use of low cost storage cards employing near-field communications technology allows the cryptographic key backup to be performed securely and with little, or no, user intervention.

It will be appreciated that the invention is suitable for backing-up keys used to secure content downloaded according to a variety of protocols and specifications, for example the Open Mobile Alliance (OMA) DRM version 2 specification.

The invention is described further hereinafter, by way of example only, with reference to the accompanying drawing which is a schematic block diagram of a mobile device arranged in accordance with the present invention.

Turning now to the drawing, there is illustrated a mobile device such as a cell phone 10 and which is arranged for the generation, and storing of cryptographic key information so as to access secure content transmitted thereto and for which the user of the device 10 may well have made a substantial financial outlay.

It is important therefore to allow the user to recreate, in a secured fashion, the cryptographic information it originally held within the device 10 should the data for some reason become inaccessible or lost.

The illustrated embodiment relates to the backing-up of one or more keys used to store content required according to DRM specifications such as those outlined by way of the OMA. According to such specific methods, mobile devices are equipped with a so-called DRM agent which is a function provided to allow for the procurement of digital rights so as to reproduce, or otherwise use, downloaded content. Such rights are stored as so-called Rights Objects and critical parts of these Rights Objects are encrypted for the use of a given DRM agent using, for example, its given (Rivest Shamir Adelman) RSA public key. The corresponding RSA private key is required to access such rights and subsequently the content, being held by the user.

The illustrated embodiment is based upon a device which uses a RSA public/private key pair for the cryptographic handling of data.

As illustrated, in accordance with the illustrated embodiment, the device 10 is associated with a near-field communications card 12 which, in a wireless fashion is arranged to receive by induction both its power and required data from the device 10.

Internal to the device 10 is a secured domain 14 within which the public/private keypair is created and within which the private key is secured in such a way that it is unknown to all parties, including the owner/user of the device 10. This ensures that the device containing this private key cannot itself be cloned and so enhances the security offered by the public/private key pair. The private key can only be exploited by writing data into the secured domain 14, which provides digital signing and decryption operations. Computations are performed only within the secured domain 14 and the results are then read-out without the private key itself becoming exposed.

The creation of a RSA private key requires two specific functions. First a random number generator 16 is required to define candidate numbers as potential prime factors p and q of the RSA public modulus n, and subsequent to the generation, a function to test these candidate numbers for primality. Knowledge of either of the prime factors p or q, in conjunction with the public modulus n proves to be sufficient for the reconstruction of the private key.

The present invention advantageously employs the random number generator 16 so as to allow for a simple secret-sharing scheme which allows the backing-up of the key data.

In accordance with this embodiment of the present invention, once the public/private keypair creation process has been completed, the two prime factors p and q are known within the secured domain 16 whilst the public modulus n formed in the multiplier 18 is available outside of the secured domain 14.

In general, it is appreciated that the value n is chosen to be a number of a specific size, for example 1024 bits. In this manner, a simple secret sharing scheme can be implemented through the generation of an additional random number r within the random number generator 16 and which is of a bit-length half of that of the bit length of the public modulus n, i.e. in this example 512 bits. It will be appreciated, the creation of this random number r is performed within the secured domain 14.

Since it can be ensured that a minimum value of (p,q) which is defined at block 20 as s cannot have a bit-length greater than 512 bits, then it will be readily appreciated that an exclusive OR operation of the values of s and r will have a bit-length of exactly 512 bits. If necessary, the bit string representing s can be prepended with zeros in order to extend its length to 512 bits.

Importantly, it should be appreciated that a knowledge of the bits arising from the exclusive OR operation of the values of s and r conveys no information about either s or r, and even the bit-length of s is concealed.

In accordance with the present invention, the values of s and r are subject to an exclusive OR operation at block 22 and the result delivered to a near field communications writer 24 for writing, in a wireless fashion, to the near field communications card 12.

As will be appreciated, the illustrated embodiment of the present invention provides for an example of a secret-sharing scheme allowing for the secure recreation of cryptographic key data and, in this illustrated embodiment, the secret shared between the user device 10 and a remote so-called trusted authority, is the value s.

The trusted authority with whom one share of the secret s is lodged has been assumed not to collude with the user of the device 10 to reconstruct the private key in an unauthorised manner. Such a trusted authority is also assumed to have its own public/private keypair, the public key of which, if necessary, being certified by an even higher security authority.

Also, it is assumed that the trusted authority checks to ensure that the requirements which must be met before the key recovery can be performed are satisfied.

By reference to the accompanying drawing, it should be appreciated that the secret sharing operation is completed as follows.

First, the random number r generated within the random number generator 16 is encrypted using the public key of the trusted authority. Such an encryption operation is performed inside the secured domain 14 of the device 10 within the encryption block 26 so that only the encrypted result T is visible to the user, and indeed a third party. This encrypted result T is then delivered to the trusted authority.

As mentioned previously, the result of the exclusive OR operation between the values of s and r is then delivered in a wireless manner to the write-once near-field communications card 12 and the user instructed to keep the card in a safe place for retrieval and use when key-data reconstruction is required.

In an event that such key reconstruction is required, for example in order to recover content after a device failure, the user need simply present the card 12 to the trusted authority which authority is then able to read directly the result of the exclusive OR operation of the values s and r.

Also, through the use of its private key, the trusted authority can decrypt the message T comprising the encrypted version of r that it received when the secret sharing operation was performed and so, through the recovery of the value of r, and by means of a simple exclusive OR operation with the data stored on the near field communications card 12, the value of s can then be recovered.

The recovery of s then permits the reconstruction of the private key information and so the recovery of any information stored under that private key.

Of course, any private key, or secret secured data can be shared in an appropriate manner by the same technique as discussed above and regardless of the bit-length of the data. Thus, the invention is equally applicable for example to elliptic curve cryptosystem private key information or indeed symmetric cipher key information. Of course, other, and more sophisticated, secret sharing schemes can be employed if required, the key feature of the invention being the use of the near-field communications card in the secret sharing scheme.

It should of course be appreciated that, mathematically, it is arbitrary whether the trusted authority receives r or the result of the exclusive OR operation, so long as one is received and the other is stored on the near-field communications device. Providing r to the trusted authority in this example however is considered advantageous since the number sent to the trusted authority then has no meaningful relationship with the key information. Also, the user is then protected against weakness in the random number generation.

As will be appreciated, the invention can advantageously be applied to third generation mobile cell phones and multimedia devices which are intended to receive audio, video and executable content targeted at a specific recipient. This recipient will generally be identified by an internal DRM agent function which has its own public/private key pairs to facilitate reception of rights information.

Other devices that could benefit from such a low-cost buried key back-up scheme as that presented by the present invention includes smart cards, where the smart card acts a root key carrier for storage, trusted computing devices according to the specifications of the Trusted Computing Group (TCG) wherein an embedded trusted platform mode (TPM) contains a buried RSA private key, and personal identity systems such as electronic passports and driving licenses, where the ability to produce evidence of previous ownership of a buried secret may serve to facilitate the process of re-issuing new identity tokens in the event of loss or damage to the original.

The invention is not restricted to the details of the foregoing embodiment. For example the secret sharing need not only be deployed across two parties. Through an appropriate choice of mathematical scheme, it is possible to devise sharing schemes in which more than two shares are distributed between a corresponding number of parties, and furthermore in which optionally not all shares are required for reconstruction. For example any four shares from seven may be used. The essence of the invention is of course the storing of the user's share(s) on the NFC card.

As will therefore be appreciated, the present invention provides for the use of an extremely low cost write-once device employing near-field communications technology for the storage of a user's share of security data within a secret sharing scheme. As noted, such cards require and contain only a small chip which receives both data and power by magnetic induction and so comprise extremely cost-effective media for the storage of the user's share of the secret.

In its most general sense, it will be appreciated that the present invention allows for the sharing of a secret, for data-security access purposes, between a user and a trusted authority whereby the secret data can only be reconstructed by collaboration between the user and the trusted authority, and wherein the recording of the user's share of that secret is easily, reliably and cost-effectively integrated within a simple electronic storage device.

1. A method of security data restoration for a user device for back-up purposes in which the said security data can be restored through the interaction of a first and at least a second portion of data, including the steps of storing the first portion of data on a storage medium remote from the device, writing the at least second portion of data to wireless storage means, and, when restoration is required, communicating the at least second portion of data from the wireless storage means to the said storage medium so as to allow for the interaction of the first and the at least second portion of data.

2. A method as claimed in claim 1, wherein the security data comprises encryption data.

3. A method as claimed in claim 2, wherein the encryption data comprises cryptographic key data.

4. A method as claimed in claim 1, wherein the user device comprises a mobile device.

5. A method as claimed in claim 4, wherein the mobile device comprises a mobile radio communications device.

6. A method as claimed in claim 1, wherein the said storage medium comprises a trusted authority for the secure storage of the said first portion of data.

7. A method as claimed in claim 1, wherein the said wireless storage means comprises at least one near-field communications device.

8. A method as claimed in claim 1, wherein a plurality of said second portions of data are required for the restoration of the security data.

9. Security data restoration system for a user device for backup purposes in which the said security data can be restored through the interaction of a first portion and at least a second portion of data, the system comprising a storage medium arranged for storing the first portion of data remote from the device, wireless storage means arranged for receiving the at least second portion of data and the system being arranged such that, when restoration is required, the at least second portion of data within the wireless storage means can be communicated to the said storage medium so as to allow for the interaction of the first and the at least second portion of data.

10. A system as claimed in claim 9, wherein the security data comprises encryption data.

11. A system as claimed in claim 10, wherein the encryption data comprises cryptographic key data.

12. A system as claimed in claim 9, wherein the user device comprises a mobile device.

13. A system as claimed in claim 12, wherein the mobile device comprises a mobile radio communications device.

14. A system as claimed in claim 1, wherein the said storage medium comprises a trusted authority for the secure storage of the said first portion of data.

15. A system as claimed in claim 1, wherein the wireless storage means comprises at least one near-field communications device.

16. A system as claimed in claim 9, wherein a plurality of said second portions of data are required for the restoration of the security data.

17. A method of backing-up security data of a user device and comprising the step of writing a first portion of security data to writable wireless storage means for subsequent retrieval and use in a backup procedure.

18. A method as claimed in claim 17, wherein the wireless writable storage means comprises at least one near-field communications device.

19. A back up device for the storage of security data derived from a user device and for subsequent use in recreating security data within the device, and comprising a wireless writable storage device.

20. A device as claimed in claim 19 and comprising a near field communications device.

21. A method of security data restoration substantially as hereinbefore described and with reference to the accompanying drawing.

22. A security data restoration system substantially as hereinbefore described with reference to, and as illustrated in, the accompanying drawing.

23. A backup method for a user device substantially as hereinbefore described with reference to the accompanying drawing.

24. A backup device substantially as hereinbefore described with reference to, and as illustrated in, the accompanying drawing.
